(19) United States
(12) Patent Application Publication
(10) Pub. No.: US 2022/0078385 A1
(43) Pub. Date: Mar. 10, 2022

(54) PROJECTION METHOD BASED ON AUGMENTED REALITY TECHNOLOGY AND PROJECTION EQUIPMENT

(71) Applicant: IVIEW DISPLAYS (SHENZHEN) COMPANY LTD., Shenzhen (CN)

(72) Inventors: Steve Yeung, Hong Kong (CN); Zhiqiang Gao, Hong Kong (CN); Xiang Li, Shenzhen (CN); Wenxiang Li, Shenzhen (CN); Mingnei Ding, Shenzhen (CN)

(21) Appl. No.: 17/530,860

(22) Filed: Nov. 19, 2021

Related U.S. Application Data
(63) Continuation of application No. PCT/CN2019/110873, filed on Oct. 12, 2019.

(30) Foreign Application Priority Data
Aug. 29, 2019 (CN) 201910807392.5

(51) Int. Cl. H04N 9/31; G06T 17/00; H04N 5/232; G06T 7/50

(52) U.S. Cl. CPC H04N 9/3185; G06T 17/00; G06T 2200/08; H04N 9/317; G06T 7/50; H04N 5/23238

(57) ABSTRACT

Embodiments of the present disclosure relate to a projection method based on augmented reality technology, and a projection equipment (10). In the projection method applicable to the projection equipment (10) includes, the image information of a real space (20) is captured in advance, the 3D virtual spatial model is constructed based on the image information, the optimal projection region is determined based on the 3D virtual spatial model, and a projection target (30) is projected to the optimal projection region. In this way, seamless integration of information about real world and virtual world is achieved, a user does not need to wear a complicated wearable equipment, and user experience is improved.

### TECHNICAL FIELD

Embodiments of the present disclosure relate to the technical field of projection equipment, and in particular, relate to a projection method based on augmented reality technology, and a projection equipment.

### BACKGROUND

Augmented reality is a new technology of seamlessly integrating real world information and virtual world information. By augmented reality, entity information (including visual information, voice, taste, tactile sensation, and the like) that is hard to experience in a specific time and spatial range in the real world is simulated and superimposed by the computer technology and the like, and the virtual information is applied to the real world and perceived and sensed by human sense, thereby achieving a sense experience exceeding reality. A real environment and a virtual object are superimposed in real time to the same picture or space, and displayed.

Augmented reality not only exhibits information of the real world, but also displays the virtual information. These two types of information are complementary to each other, and superimposed to each other. In visualized augmented reality, a user combines the real world with computer graphs by using a helmet-mounted display, and thus observes the real world around. Augmented reality includes multimedia, 3D modeling, real-time video display and control, multi-sensor fusion, real-time tracking, scenario fusion, and the like new technologies and means. Augmented reality provides information different from that perceivable by humans in generally conditions.

### SUMMARY

To solve the above technical problem, embodiments of the present disclosure provide a projection method based on augmented reality technology, and a projection equipment, such that user experience is improved with no need of wearing a conventional wearable equipment.

The embodiments of the present disclosure provide a projection method based on augmented reality technology, which is applicable to a projection equipment. The projection equipment is capable of projecting a projection target. The projection method includes:

capturing image information of a real space;

constructing a 3D virtual spatial model based on the image information;

determining an optimal projection region based on the 3D virtual spatial model; and

projecting the projection target to the optimal projection region.

The embodiments of the present disclosure further provide a projection equipment. The projection equipment includes: at least one processor; and

a memory communicably connected to the at least one processor; wherein the memory stores instructions executable by the at least one processor, wherein the instructions, when executed by the at least one processor, cause the at least one processor to perform:

capturing image information of a real space;

constructing a 3D virtual spatial model based on the image information;

determining an optimal projection region based on the 3D virtual spatial model; and

projecting the projection target to the optimal projection region.

As compared with the related art, in the projection method based on augmented reality technology according to the embodiments of the present disclosure, the image information of a real space is captured in advance, the 3D virtual spatial model is constructed based on the image information, the optimal projection region is determined based on the 3D virtual spatial model, and a projection target is projected to the optimal projection region. In this way, seamless integration of information about real world and virtual world is achieved, a user does not need to wear a complicated wearable equipment, and user experience is improved.

### BRIEF DESCRIPTION OF THE DRAWINGS

For clearer descriptions of technical solutions according to the embodiments of the present disclosure, drawings that are to be referred for description of the embodiments are briefly described hereinafter. Apparently, the drawings described hereinafter merely illustrate some embodiments of the present disclosure. Persons of ordinary skill in the art may also derive other drawings based on the drawings described herein without any creative effort.

FIG. 1 is a schematic diagram of an application environment according to an embodiment of the present disclosure;

FIG. 2 is a schematic flowchart of a projection method based on augmented reality technology according to an embodiment of the present disclosure;

FIG. 3 is a schematic flowchart of S20 in FIG. 2;

FIG. 4 is a schematic flowchart of S211 in FIG. 3;

FIG. 5 is a schematic flowchart of S30 in FIG. 2;

FIG. 6 is a schematic flowchart of S32 in FIG. 5;

FIG. 7 is a schematic flowchart of S322 in FIG. 6;

FIG. 8 is a schematic flowchart of S50 in FIG. 2 according to an embodiment;

FIG. 9 is a schematic flowchart of S50 in FIG. 2 according to another embodiment;

FIG. 10 is a structural block diagram of a projection device based on augmented reality technology according to an embodiment of the present disclosure; and

FIG. 11 is a structural block diagram of a projection equipment according to an embodiment of the present disclosure.

### DETAILED DESCRIPTION

The technical solutions contained in the embodiments of the present disclosure are described in detail clearly and completely hereinafter with reference to the accompanying drawings for the embodiments of the present disclosure. Apparently, the described embodiments are only a portion of embodiments of the present disclosure, but not all the embodiments of the present disclosure. All other embodiments obtained by a person of ordinary skill in the art based on the embodiments of the present disclosure without creative efforts shall fall within the protection scope of the present disclosure.

Unless otherwise defined, all the technical and scientific terms used in this specification convey the same meanings as the meanings commonly understood by a person skilled in the art to which the present disclosure pertains. In addition, terms of “first,” “second,” and the like in the present disclosure are only used for description, but shall not be understood as indication or implication of relative importance or implicit indication of the number of the specific technical features. Therefore, the features defined by the terms “first” and “second” may explicitly or implicitly include at least one of these features. The technical solutions according to various embodiments of the present disclosure may be combined, as long as persons of ordinary skills in the art may practice the technical solution combinations. When combinations of the technical solutions are contradicted or fail to be implemented, it should be considered that the combinations are not existent, and are not within the protection scope of the present disclosure.

For better understanding of the present disclosure, the present disclosure is described in detail with reference to attached drawings and specific embodiments. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. In the description of the present disclosure, it should be understood that the terms “up,” “down,” “inner,” “outer,” “bottom,” and the like indicate orientations and position relationships which are based on the illustrations in the accompanying drawings, and these terms are merely for ease and brevity of the description, instead of indicating or implying that the equipment or elements shall have a particular orientation and shall be structured and operated based on the particular orientation. Accordingly, these terms shall not be construed as limiting the present disclosure. In addition, the terms “first”, “second,” and “third” are merely for the illustration purpose, and shall not be construed as indicating or implying a relative importance.

Unless the context clearly requires otherwise, throughout the specification and the claims, technical and scientific terms used herein denote the meaning as commonly understood by a person skilled in the art. Additionally, the terms used in the specification of the present disclosure are merely for description the embodiments of the present disclosure, but are not intended to limit the present disclosure. As used herein, the term “and/or” in reference to a list of one or more items covers all of the following interpretations of the term: any of the items in the list, all of the items in the list and any combination of the items in the list.

In addition, technical features involved in various embodiments of the present disclosure described hereinafter may be combined as long as these technical features are not in conflict.

An embodiment of the present disclosure provides a projection method based on augmented reality technology. The method is applicable to a projection equipment. The projection equipment is capable of projecting a projection target. In the projection method, the image information of a real space is captured in advance, the 3D virtual spatial model is constructed based on the image information, the optimal projection region is determined based on the 3D virtual spatial model, and a projection target is projected to the optimal projection region. In this way, seamless integration of information about real world and virtual world is achieved, a user does not need to wear a complicated wearable equipment, and user experience is improved.

An application environment of the projection method based on augmented reality technology is described hereinafter by using examples.

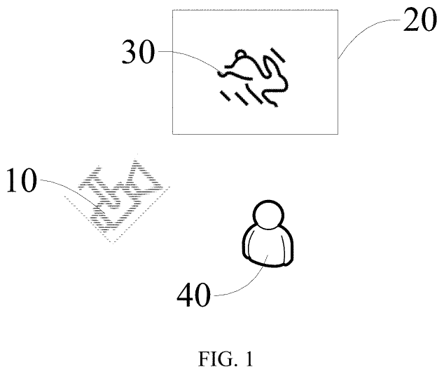

FIG. 1 is a schematic diagram of an application environment of a projection method based on augmented reality technology according to an embodiment of the present disclosure. As illustrated in FIG. 1, the application environment involves a projection equipment 10, a real space 20, a projection target 30, and a user 40. The projection equipment 10 is disposed in the real space 20, and capable of projecting the projection target 30 to the real space 20, such that the virtual projection target 30 is applied to a real world and perceived by the user 40, thereby achieving sense experience beyond reality.

A memory is built in the projection equipment 10, and the memory stores projection information of the projection target 30. The projection information includes a size, a motion direction, a rotation angle, and the like of the projection target 30. The projection equipment 10 is capable of projecting the projection information corresponding to the projection target 30 to the real space. Meanwhile, the projection equipment 10 is further capable of capturing image information of the real space 20, constructing a 3D virtual spatial model based on the image information, determining an optimal projection region based on the 3D virtual spatial model, and projecting the projection target 30 to the optimal projection region.

Specifically, the projection equipment 10 includes a processor, a memory, a projection unit, a short-range wireless communication unit, and a network communication unit. The processor is a processing equipment that controls a corresponding unit of the projection equipment 10. The projection equipment is further capable of capturing image information of the real space 20, constructing a 3D virtual spatial model based on the image information, determining an optimal projection region based on the 3D virtual spatial model, and projecting the projection target 30 to the optimal projection region. The memory stores data required by the operation of the processor, and stores projection information of the projection target 30. The projection information includes a size, a motion direction, a rotation angle, and the like of the projection target 30. The projection equipment 10 is capable of projecting the projection information corresponding to the projection target 30 to the real space. The projection unit projects the projection information of the projection target 30 stored in the memory to the real space. The projection unit projects an image to a projection surface of the real space by using a light source (such as, a lamp and a laser). Specifically, in the case that laser source is used, since point-like drawing is performed by scanning on the projection surface of the real space, all positions on the projection surface are focused without brightening a black portion.

In some embodiments, the projection equipment 10 further includes a gyroscope sensor and an acceleration sensor, and predetermined motion information of the projection equipment 10 may be acquired in combination with detection results of the gyroscope sensor and the acceleration sensor. The predetermined motion information includes a predetermined movement direction and a predetermined movement distance. In some embodiments, the projection equipment 10 further includes an image capturing equipment, for example, a digital single-lens reflex camera. The image capturing equipment is configured to capture image information of the real space 20.

The real space 20 refers to a physical space that objectively exists. The physical space is a three-dimensional space with three dimensions of length, width, and height. The real space 20 includes a projectable region, such as a wall, a floor, or the like, and the projection equipment 10 is capable of projecting the projection target 30 to the projectable region.

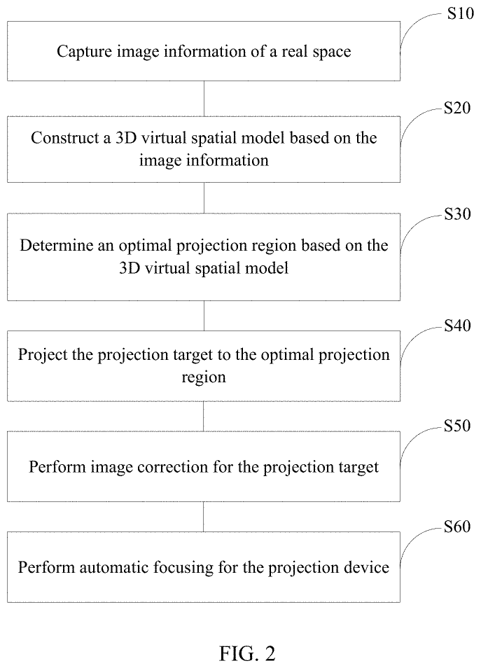

FIG. 2 is a schematic flowchart of a projection method based on augmented reality technology according to an embodiment of the present disclosure. As illustrated in FIG. 2, the projection method based on augmented reality technology includes the following steps.

In S10, image information of a real space is captured.

Specifically, the image information of the real space is captured by the image capturing equipment. The image capturing equipment may be a digital single-lens reflex camera.

The real space refers to a physical space that objectively exists. The physical space is a three-dimensional space with three dimensions of length, width, and height. The real space includes a projectable region, such as a wall, a floor, or the like, and the projection equipment is capable of projecting the projection target to the projectable region.

The image information is not necessarily the image itself captured by the image capturing equipment, but may also be a corrected image obtained by applying correction based on lens characteristic information so as to suppress distortion of the image. Herein, lens characteristic information refers to information indicating a lens distortion characteristic of the lens equipped with the camera that captures the image information. The lens characteristic information may be a known distortion characteristic of the corresponding lens, a distortion characteristic obtained by calibration, or a distortion characteristic obtained by performing image processing on the image information. It should be noted that the lens distortion characteristic may include not only barrel distortion and pincushion distortion, but also distortion caused by special lenses such as fisheye lenses.

In S20, a 3D virtual spatial model is constructed based on the image information.

Specifically, panorama image information is acquired by combining the image information; 3D dimensional data of the real space is parsed out based on the panorama image information; and the 3D virtual spatial model is constructed based on the panorama image information and the 3D dimensional data.

In S30, an optimal projection region is determined based on the 3D virtual spatial model.

Specifically, a projectable region is firstly determined by detecting an imaging region acquired based on the 3D virtual spatial model; different grades of projectable regions are subsequently acquired by grading the projectable regions; and the optimal projection region is finally determined based on the projection target and the different grades of projectable regions.

In S40, the projection target is projected to the optimal projection region.

Specifically, a memory is built in the projection equipment, and the memory stores projection information of the projection target. The projection information includes a size, a motion direction, a rotation angle, and the like of the projection target. The projection equipment is capable of projecting the projection information corresponding to the projection target to the real space.

Specifically, the projection equipment includes a processor, a memory, a projection unit, a short-range wireless communication unit, and a network communication unit. The processor is a processing equipment that controls a corresponding unit of the projection equipment. The projection equipment is further capable of capturing image information of the real space, constructing a 3D virtual spatial model based on the image information, determining an optimal projection region based on the 3D virtual spatial model, and projecting the projection target to the optimal projection region. The memory stores data required by the operation of the processor, and stores projection information of the projection target. The projection information includes a size, a motion direction, a rotation angle, and the like of the projection target. The projection equipment is capable of projecting the projection information corresponding to the projection target to the real space. The projection unit projects the projection information of the projection target stored in the memory to the real space. The projection unit projects an image to a projection surface of the real space by using a light source (such as, a lamp and a laser). Specifically, in the case that laser source is used, since point-like drawing is performed by scanning on the projection surface of the real space, all positions on the projection surface are focused without brightening a black portion.

In some embodiments, the projection equipment further includes a gyroscope sensor and an acceleration sensor, and predetermined motion information of the projection equipment may be acquired in combination with detection results of the gyroscope sensor and the acceleration sensor. The predetermined motion information includes a predetermined movement direction and a predetermined movement distance. In some embodiments, the projection equipment further includes an image capturing equipment, for example, a digital single-lens reflex camera. The image capturing equipment is configured to capture image information of the real space.

In the projection method based on augmented reality technology according to the embodiments of the present disclosure, the image information of a real space is captured in advance, the 3D virtual spatial model is constructed based on the image information, the optimal projection region is determined based on the 3D virtual spatial model, and a projection target is projected to the optimal projection region. In this way, seamless integration of information about real world and virtual world is achieved, a user does not need to wear a complicated wearable equipment, and user experience is improved.

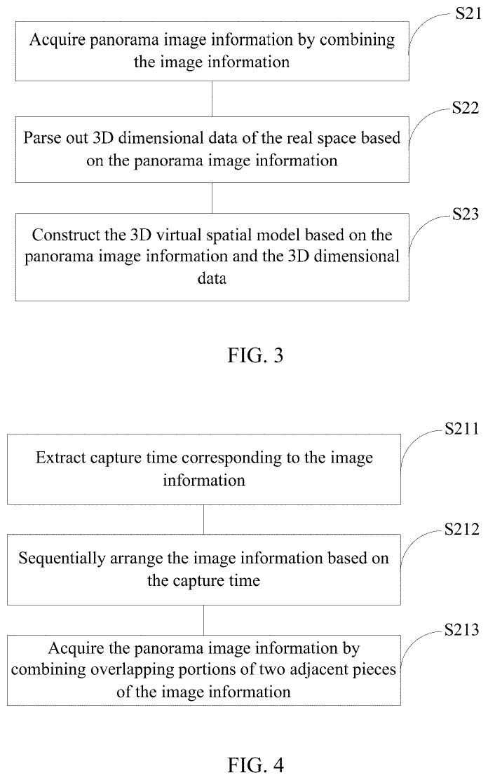

For better constructing the 3D virtual spatial model based on the image information, in some embodiments, referring to FIG. 3, S20 includes the following steps.

In S21, panorama image information is acquired by combining the image information.

Specifically, the image capturing equipment is capable of capturing a plurality of pieces of image information, and the plurality of pieces of the image information need to be processed to obtain the panorama image information.

Specifically, one piece of image information corresponds to one capture time (image capture time), such that the image information is sequentially arranged based on the capture time in time sequence or different perspectives, and then the panorama image information is acquired by combining overlapping portions of two adjacent pieces of the image information.

The combining process uses the image combination technology, which is a technology of combining several images with overlapping portions (which may be acquired at different times, from different perspectives, or by different sensors) into a seamless panorama image or a high-resolution image. The image alignment and the image fusion are two key technologies for image combination. The image alignment is the foundation of image fusion, and a calculation load of an image alignment algorithm is generally enormous. Therefore, development of the image combination technology is, to a great extent, dependent on innovation of the image alignment technology. Early image alignment techniques mainly use a point matching method. The point matching method has a low speed and a low precision, and often requires manual selection of initial matching points, which is not adapt to the fusion of large amounts of data of images. Many methods are available for image combination, and different algorithm steps may have specific differences, but the general process is the same. Generally, image combination mainly includes the following five steps: 1. Image information preprocessing, the image information preprocessing includes the basic operations of digital image processing (such as denoising, edge extracting, histogram processing, or the like), establishing an image matching template, and performing some sort of image transformation (such as Fourier transform, wavelet transform, or the like). 2. Image information alignment: the corresponding position of the template or feature point in the image to be combined in the reference image is found out by using matching strategies, and then the transformation relationship between the two images is determined. 3. Establishment of image information and a transformation model: parameter values in the mathematical model are calculated based on the corresponding relationship between the template or the image features, such that the mathematical transformation models of the two images are established. 4. Image information unified coordinate transformation: the image to be combined is transformed into a coordinate system of the reference image based on the established mathematical transformation model, and the unified coordinate transformation is completed. 5. Image information fusion reconstruction: overlapping regions of the image to be combined are fused to acquire smooth and seamless panorama image information.

In S22, 3D dimensional data of the real space is parsed out based on the panorama image information.

Specifically, the panorama image information records a continuous parallax of the real space in a unique imaging fashion, and conceals the scene of the real space therein. Therefore, depth extraction calculation and error analysis may be performed based on the panorama image information, and the 3D dimensional data corresponding to the real space is acquired.

In S23, the 3D virtual spatial model is constructed based on the panorama image information and the 3D dimensional data.

The panorama image information includes a plurality of pieces of physical image information. The physical image information refers to physical image information acquired by capturing pictures of physical objects (walls, floors, tables and chairs, or the like) in the real space. The 3D virtual spatial model is constructed based on the physical image information and the corresponding 3D dimensional data.

For acquiring panorama image information by combining the image information, in some embodiments, referring to FIG. 4, S21 includes the following steps:

In S211, capture time corresponding to the image information is extracted.

Specifically, each piece of image information corresponds to one capture time, and the capture time is an image capture time when the image information is generated. For example, the capture time corresponding to image information 1 is t1, the capture time corresponding to image information 2 is t2, the capture time corresponding to image information 3 is t3, and

the capture time corresponding to image information 4 is t4.

In S212, the image information is sequentially arranged based on the capture time.

Specifically, the capture times are arranged in a time sequence, and further the image information corresponding to the capture times is arranged in the time sequence. For example, the capture time t1, the capture time t2, the capture time t3, and the capture time t4 are arranged as t4, t3, t2, and t1 in terms of the time sequence. The image information is sequentially arranged as the image information 4, the image information 3, the image information 2, and the image information 1 based on the image information corresponding to the capture times with the time sequence of t4, t3, t2, and t1.

In S213, the panorama image information is acquired by combining overlapping portions of two adjacent pieces of the image information.

Specifically, since each two adjacent pieces of image information have overlapping portions, the panorama image information is acquired by combining the overlapping portions of two adjacent pieces of the image information. For example, two adjacent image information 4 and 3 are combined, two adjacent image information 3 and 2 are combined, two adjacent image information 2 and 1 are combined, and finally the panorama image information is acquired, wherein the panorama image information includes the image information 1, the image information 2, the image information 3, and the image information 4.

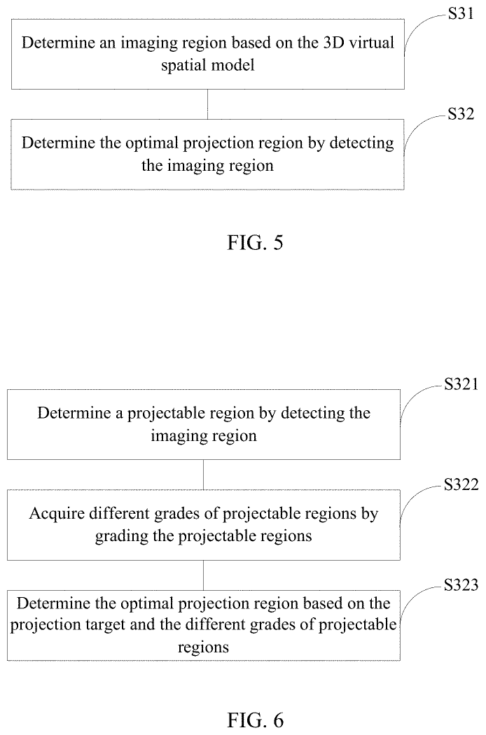

For determining an optimal projection region based on the 3D virtual spatial model, in some embodiments, referring to FIG. 5, S30 includes the following steps.

In S31, an imaging region is determined based on the 3D virtual spatial model.

Specifically, the 3D virtual space model includes a plurality of virtual physical models, wherein the plurality of virtual physical modules are the 3D virtual physical models constructed based on physical image information and the corresponding 3D dimensional data. Each 3D physical model has corresponding dimensional information (length, width, and height), a projection area of each 3D physical model may be determined based on the corresponding dimensional information of the same, and further the imaging region is determined based on the projection area.

In S32, the optimal projection region is determined by detecting the imaging region.

Specifically, a projectable region is determined by detecting the imaging region; different grades of projectable regions are acquired by grading the projectable regions; and the optimal projection region is determined based on the projection target and the different grades of projectable regions.

For better determining the optional projection region by detecting the imaging region, in some embodiments, referring to FIG. 6, S32 includes the following steps.

In S321, a projectable region is determined by detecting the imaging region.

Specifically, the imaging region corresponds to length information, and an area of the imaging region is acquired based on the length information of the imaging region. The projectable region is determined based on whether the area of the imaging region is consistent with a predetermined projection area. For example, in the case that the area of the imaging region is less than the predetermined projection area, the imaging region may not be used as the projectable region. Still for example, in the case that the area of the imaging region is greater than or equal to the predetermined projection area, the imaging region may be used as the projectable region.

In S322, different grades of projectable regions are acquired by grading the projectable regions.

Specifically, an area of the projectable region is acquired based on dimensional information of the projectable region, and the projectable region is graded based on the area to acquire the different grades of projectable regions. It should be understood that the higher the grades, the greater the area of the projectable region.

In S323, the optimal projection region is determined based on the projection target and the different grades of projectable regions.

Specifically, the dimensional information and/or motion information of the projection target is acquired; and the optimal projection region is determined based on the dimensional information and/or the motion information, and the different grades of projectable regions. For example, a length and width in the dimensional information of the projection target are respectively 30 cm and 20 cm, a motion distance in the motion information is 10 cm, an area of a minimum projectable region desired by the projection target is (30+10)*20=800 cm²; correspondingly, in the different grades of projectable regions, a projectable region with the area being greater than the area of the minimum projectable region is the optimal projection region. For example, in the different grades of projectable regions, the area of the projectable region in a first grade is in the range of 300 to 400 cm², the area of the projectable region in a second grade is in the range of 500 to 600 cm², the area of the projectable regions in a third grade is in the range of 700 to 800 cm², and the area of the projectable region in a fourth grade is in the range of 900 to 1000 cm². The areas of the projectable region in the first grade, the projectable region in the second grade, and the projectable region in the third grade in the projectable regions in the different grades are all less than the area 900 cm² of the minimum projectable region. Therefore, none of the projectable region in the first grade, the projectable region in the second grade, and the projectable region in the third grade is the optimal projection region. In the projectable regions in the different grades, the area 900 cm² of the projectable region in the fourth grade is greater than the area 800 cm² of the minimum projectable region. In this case, the projectable region in the fourth grade is the optimal projection region.

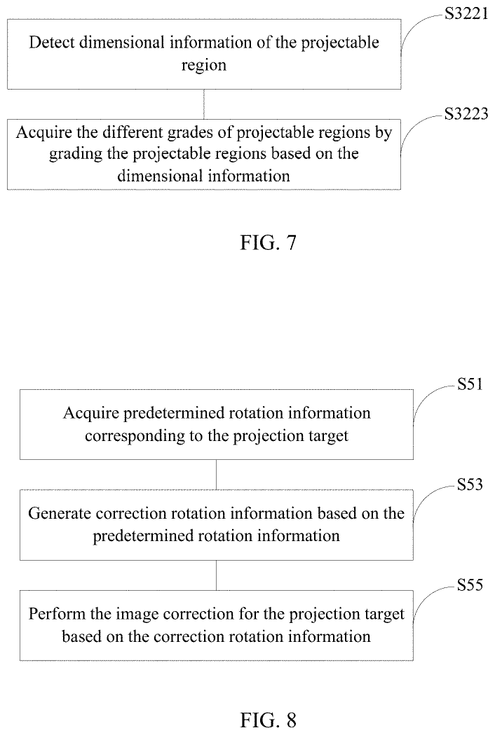

For acquiring the different grades of projectable regions by grading the projectable regions, in some embodiments, referring to FIG. 7, S322 includes the following steps.

In S3221, dimensional information of the projectable region is detected.

In S3222, the different grades of projectable regions are acquired by grading the projectable regions based on the dimensional information.

Specifically, an area of the projectable region is acquired based on the dimensional information of the projectable region; and the different grades of projectable regions are determined based on the area of the acquired projectable region. For example, the area of the projectable region in the first grade is predetermined in the range of 300 to 400 cm², the area of the projectable region in the second grade is predetermined in the range of 500 to 600 cm², the area of the projectable region in the third grade is predetermined in the range of 700 to 800 cm², and the area of the projectable region in the fourth grade is predetermined in the range of 900 to 1000 cm². In the case that the detected area of the projectable region is 600 cm², the projectable region is determined as the projectable region in the second grade.

For accurately detecting the dimensional information of the projectable region, in some embodiments, S3221 includes the following steps:

detecting the projectable region by a dimension detection region, wherein the dimension detection region corresponds to a detection radius, and the dimension detection region is formed based on the detection radius; and

in response to an area of the dimension detection region being less than an area of the projectable region, increasing the detection radius corresponding to the dimension detection region by a predetermined length, and continuing detecting the projectable region based on the increased dimension detection region.

In some embodiments, upon projecting the projection target to the optimal projection region, the method further includes the following steps.

In S50, image correction is performed for the projection target.

Specifically, predetermined rotation information corresponding to the projection target is acquired; correction rotation information is generated based on the predetermined rotation information; and the image correction is performed for the projection target based on the correction rotation information.

For better performing the image correction for the projection target, in some embodiments, referring to FIG. 8, S50 includes the following steps.

In S51, predetermined rotation information corresponding to the projection target is acquired.

The predetermined rotation information includes a predetermined rotation angle and a predetermined rotation direction. The predetermined rotation information of the projection target is prestored in a memory of the projection equipment.

In S53, correction rotation information is generated based on the predetermined rotation information.

Specifically, the correction rotation information is generated based on the predetermined rotation angle and the predetermined rotation direction. The correction rotation information includes a correction rotation angle and a correction rotation direction. It may be understood that the correction rotation angle is equal to the predetermined rotation angle. The correction rotation direction is opposite to the predetermined rotation direction. Generating the correction rotation information based on the predetermined rotation information includes generating a correction rotation angle identical to the predetermined rotation angle; and generating a correction rotation direction opposite to the predetermined rotation direction, wherein the correction rotation angle and the correction rotation direction constitute the correction rotation information.

In S55, the image correction is performed for the projection target based on the correction rotation information.

Specifically, the rotation angle and the rotation direction of the projection target are corrected based on the correction rotation angle and the correction rotation direction.

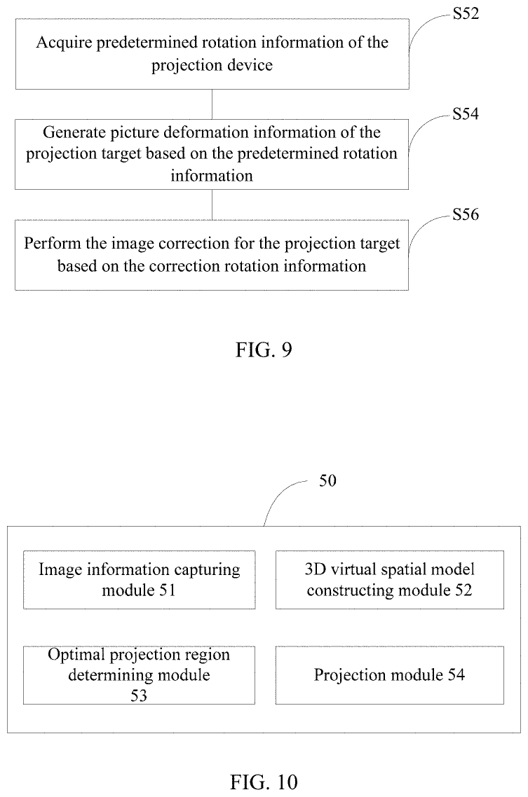

For better performing the image correction for the projection target, in some embodiments, referring to FIG. 9, S50 includes the following steps.

In S52, predetermined rotation information of the projection equipment is acquired.

The predetermined rotation information includes a predetermined rotation angle and a predetermined rotation direction. The predetermined rotation information of the projection equipment is prestored in the memory of the projection equipment.

In S54, picture deformation information of the projection target is generated based on the predetermined rotation information.

Specifically, the picture deformation information of the projection target is generated based on the predetermined rotation angle and the predetermined rotation direction. The picture deformation information includes picture deformation angle and picture deformation direction. It should be understood that the picture deformation angle is equal to the predetermined rotation angle. The picture deformation direction is opposite to the predetermined rotation direction.

In S56, the image correction is performed for the projection target based on the picture deformation information.

Specifically, the rotation angle and the rotation direction of the projection target are corrected based on the picture deformation angle and the picture deformation direction.

In some embodiments, upon projecting the projection target to the optimal projection region, the method further includes the following steps.

In S60, automatic focusing is performed for the projection equipment.

Specifically, information of a distance between a projection central point of the projection equipment in the 3D virtual spatial model and the projection equipment based on the 3D virtual spatial model is acquired; predetermined motion information of the projection equipment is acquired, wherein the predetermined motion information includes a predetermined movement direction and a predetermined movement distance; and the automatic focusing is performed for the projection equipment based on the information of the distance and the predetermined motion information.

It should be noted that in the above various embodiments, the steps are not subject to a definite order during execution, and persons of ordinary skill in the art would understand, based on the description of the embodiments of the present disclosure, in different embodiments, the above steps may be performed in different orders, that is, may be concurrently performed, or alternately performed.

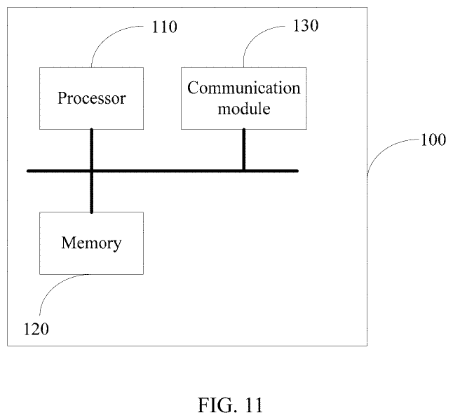

In another aspect of the embodiments of the present disclosure, a projection device 50 based on augmented reality technology is provided. Referring to FIG. 10, the projection device 50 based on augmented reality technology includes an image information capturing module 51, a 3D virtual spatial model constructing module 52, an optimal projection region determining module 53, and a projection module 54.

The image information capturing module 51 is configured to capture image information of a real space.

The 3D virtual spatial model constructing module 52 is configured to construct a 3D virtual spatial model based on the image information.

The optimal projection region determining module 53 is configured to determine an optimal projection region based on the 3D virtual spatial model.

The projection module 54 is configured to project the projection target to the optimal projection region.

Therefore, in this embodiment, the image information of a real space is captured in advance, the 3D virtual spatial model is constructed based on the image information, the optimal projection region is determined based on the 3D virtual spatial model, and a projection target is projected to the optimal projection region. In this way, seamless integration of information about real world and virtual world is achieved, a user does not need to wear a complicated wearable equipment, and user experience is improved.

It should be noted that the above projection device based on augmented reality technology may perform the projection method based on augmented reality technology according to the embodiments of the present disclosure, and include the corresponding function modules for performing the method and achieve the corresponding beneficial effects. For technical details that are not illustrated in detail in the embodiments of the projection device based on augmented reality technology, reference may be made to the description of the projection method based on augmented reality technology according to the embodiments of the present disclosure.

FIG. 11 is a schematic structural block diagram of a projection equipment 100 according to an embodiment of the present disclosure. The projection equipment 100 may be configured to implement all or part of functions of the function modules in the main control chip. As illustrated in FIG. 14, the projection equipment 100 may include a processor 110, a memory 120, and a communication module 130.

The processor 110, the memory 120, and the communication module 130 are communicatively connected with each other via a bus.

The processor 110 may be in any type, and have one or a plurality of processing cores. The processor 110 may perform single-threaded or multi-threaded operations, and is configured to parse instructions to perform operations such as acquiring data, performing logical operation functions, and issuing operation processing results.

The memory 120, as a non-transitory computer readable storage medium, may be configured to store non-transitory software programs, and non-transitory computer executable programs and modules, for example, the program instructions/modules corresponding to the projection method based on augmented reality technology according to the embodiments of the present disclosure (for example, the image information capturing module 51, the 3D virtual spatial model constructing module 52, the optimal projection region determining module 53, and the projection module 54 as illustrated in FIG. 10). The non-transitory software programs, instructions and modules stored in the memory 120, when loaded and executed by the processor 110, cause the processor 110 to perform various function applications and data processing of the projection apparatus 50 based on augmented reality technology, that is, performing the projection method based on augmented reality technology according to any of the above method embodiments.

The memory 120 may include a program memory area and a data memory area, wherein the program memory area may store operating systems and application programs desired by at least one function; and the data memory area may store data created according to the use of the projection apparatus 50 based on augmented reality technology. In addition, the memory 120 may include a high-speed random access memory, or include a non-transitory memory, for example, at least one disk storage equipment, a flash memory equipment, or another non-transitory solid storage equipment. In some embodiments, the memory 120 optionally includes memories remotely configured relative to the processor 110. These memories may be connected to the projection equipment 10 over a network. Examples of the above network include, but not limited to, the Internet, Intranet, local area network, mobile communication network and a combination thereof.

The memory 120 stores at least one instruction executable by the at least one processor 110. The at least one instruction, when loaded and executed by at least one processor 110, for example, the processor 110, causes the at least one processor 110 to perform the projection method based on augmented reality technology in any of the above method embodiments, for example, performing steps 10, 20, 30, 40, and the like in the above described method; and implementing the functions of modules 51 to 54 as illustrated in FIG. 10.

The communication module 130 is a function module configured to establish a communication connection and provide a physical channel. The communication module 130 may be any type of wireless or wired communication module 130, including, but not limited to, a Wi-Fi module or a Bluetooth module.

Further, an embodiment of the present disclosure further provides a non-transitory computer-readable storage medium. The non-transitory computer readable storage medium stores at least one computer-executable instruction. The at least one instruction, when loaded and executed by at least one processor 110, for example, the processor 110 as illustrated in FIG. 11, cause the at least one processor 110 to perform the projection method based on augmented reality technology in any of the above method embodiments, for example, performing steps 10, 20, 30, 40, and the like in the above described method; and implementing the functions of modules 51 to 54 as illustrated in FIG. 10.

The above described apparatus embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

According to the above embodiments of the present disclosure, a person skilled in the art may clearly understand that the embodiments of the present disclosure may be implemented by means of hardware or by means of software plus a necessary general hardware platform. Persons of ordinary skill in the art may understand that all or part of the processes of the methods in the embodiments may be implemented by a computer program, instructing relevant hardware, in a computer program product. The computer program may be stored in a non-transitory computer-readable storage medium. The computer program includes program instructions, wherein the computer instructions, when loaded and executed by a related equipment, cause the equipment to perform the processes of the methods in the embodiments. The storage medium may be any medium capable of storing program codes, such as a read-only memory (ROM), a random-access memory (RAM), a magnetic disk, or a compact disc read-only memory (CD-ROM).

The product may perform the projection method based on augmented reality technology according to the embodiments of the present disclosure, has corresponding function modules for performing the projection method based on augmented reality technology, and achieves the corresponding beneficial effects. For technical details that are not illustrated in detail in this embodiment, reference may be made to the description of the projection method based on augmented reality technology according to the embodiments of the present disclosure.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

What is claimed is:

1. A projection method based on augmented reality technology, applicable to a projection equipment, the projection equipment being capable of projecting a projection target, the projection method comprising:
capturing image information of a real space;
constructing a 3D virtual spatial model based on the image information;
determining an optimal projection region based on the 3D virtual spatial model; and
projecting the projection target to the optimal projection region.

2. The method according to claim 1, wherein constructing the 3D virtual spatial model based on the image information comprises:
acquiring panorama image information by combining the image information;
parsing out 3D dimensional data of the real space based on the panorama image information; and
constructing the 3D virtual spatial model based on the panorama image information and the 3D dimensional data.

3. The method according to claim 2, wherein acquiring the panorama image information by combining the image information comprises:
extracting capture time corresponding to the image information;
sequentially arranging the image information based on the capture time;
acquiring the panorama image information by combining overlapping portions of two adjacent pieces of the image information.

4. The method according to claim 1, wherein determining the optimal projection region based on the 3D virtual spatial model comprises:
determining an imaging region based on the 3D virtual spatial model; and
determining the optimal projection region by detecting the imaging region.

5. The method according to claim 4, wherein determining the optimal projection region by detecting the imaging region comprises:
determining a projectable region by detecting the imaging region;
acquiring different grades of projectable regions by grading the projectable regions; and
determining the optimal projection region based on the projection target and the different grades of projectable regions.

6. The method according to claim 5, acquiring the different grades of projectable regions by grading the projectable regions comprises:
detecting dimensional information of the projectable region; and
acquiring the different grades of projectable regions by grading the projectable regions based on the dimensional information.

7. The method according to claim 6, wherein detecting the dimensional information of the projectable region comprises:
detecting the projectable region by a dimension detection region, wherein the dimension detection region corresponds to a detection radius, and the dimension detection region is formed based on the detection radius; and
in response to an area of the dimension detection region being less than an area of the projectable region, increasing the detection radius corresponding to the dimension detection region by a predetermined length, and continuing detecting the projectable region based on the increased dimension detection region.

8. The method according to claim 7, wherein determining the optimal projection region based on the projection target and the different grades of projectable region comprises:
acquiring dimensional information and/or motion information of the projection target; and
determining the optimal projection region based on the dimensional information and/or the motion information, and the different grades of projectable regions.

9. The method according to claim 1, wherein upon projecting the projection target to the optimal projection region, the method further comprises:
performing image correction for the projection target.

10. The method according to claim 9, performing the image correction for the projection target comprises:
acquiring predetermined rotation information corresponding to the projection target;
generating correction rotation information based on the predetermined rotation information; and performing the image correction for the projection target based on the correction rotation information.

11. The method according to claim 10, wherein the predetermined rotation information comprises a predetermined rotation angle and a predetermined rotation direction; and
generating the correction rotation information based on the predetermined rotation information comprises:
generating a correction rotation angle identical to the predetermined rotation angle; and
generating a correction rotation direction opposite to the predetermined rotation direction, wherein the correction rotation angle and the correction rotation direction constitute the correction rotation information.

12. The method according to claim 9, performing the image correction for the projection target comprises:
acquiring predetermined rotation information of the projection equipment;
generating picture deformation information of the projection target based on the predetermined rotation information; and
performing the image correction for the projection target based on the picture deformation information.

13. The method according to claim 1, wherein upon projecting the projection target to the optimal projection region, the method further comprises:
performing automatic focusing for the projection equipment.

14. The method according to claim 13, performing the automatic focusing for the projection equipment comprises:
acquiring information of a distance between a projection central point of the projection equipment in the 3D virtual spatial model and the projection equipment based on the 3D virtual spatial model;
acquiring predetermined motion information of the projection equipment, wherein the predetermined motion information comprises a predetermined movement direction and a predetermined movement distance; and
performing the automatic focusing for the projection equipment based on the information of the distance and the predetermined motion information.

15. A projection equipment, comprising:
at least one processor; and
a memory communicably connected to the at least one processor; wherein the memory stores instructions executable by the at least one processor, wherein the instructions, when executed by the at least one processor, cause the at least one processor to perform:
capturing image information of a real space;
constructing a 3D virtual spatial model based on the image information;
determining an optimal projection region based on the 3D virtual spatial model; and
projecting the projection target to the optimal projection region.
